(19) United States
(12) Patent Application Publication
(10) Pub. No.: US 2026/0273639 A1
(43) Pub. Date: Sep. 17, 2026

(54) WORKPIECE FRAME WITH LOCATING FEATURES FOR MACHINE TOOLS

(71) Applicant: Rolls-Royce Corporation, Indianapolis, IN (US)

(72) Inventor: Rusty Garner, Indianapolis, IN (US)

(21) Appl. No.: 19/080,729

(22) Filed: Mar. 14, 2025

(51) Int. Cl. B23H 11/00; B23H 3/00

(52) U.S. Cl. CPC B23H 11/003; B23H 3/00

(57) ABSTRACT

A machine tool system includes a workpiece, a machine, and a workpiece frame. The workpiece frame is repositionable and relocatable on the machine in at least two different orientations to support the workpiece in the at least two different orientations during modification of the workpiece so that different sides of the workpiece are modified without requiring removal of the workpiece from the workpiece frame.

### FIELD OF THE DISCLOSURE

The present disclosure relates generally to machine tool systems, and more specifically to workpiece frames of machine tool systems.

### BACKGROUND

Electrochemical machining (ECM) is a non-contact, non-thermal material removal process capable of small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Some workpieces may be easily distorted or non-repositionable and, thus, difficult to reposition during PECM.

### SUMMARY

The present disclosure may comprise one or more of the following features and combinations thereof.

A machine tool system may comprise a three-dimensional workpiece, a machine, and a workpiece frame. The machine may be configured to modify the three-dimensional workpiece. The machine may include a tool configured to support the three-dimensional workpiece and a shaft spaced apart from the tool along a first axis and configured to move along the first axis relative to the tool to modify the three-dimensional workpiece. The workpiece frame may be repositionable and relocatable on the tool in at least two different orientations to support the three-dimensional workpiece in the at least two different orientations relative to the first axis during modification of the three-dimensional workpiece so that different sides of the three-dimensional workpiece are modified without requiring removal of the three-dimensional workpiece from the workpiece frame. The workpiece frame may include a body defining a workpiece-receiving space therein and a frame locator arranged outside of the workpiece-receiving space and extending away from the body into contact with the tool to position the workpiece frame relative to the tool so that the three-dimensional workpiece is properly aligned with the shaft in the at least two different orientations.

In some embodiments, the tool may include a base fixture configured to be coupled with the body of the workpiece frame to locate the three-dimensional workpiece relative to the shaft and an accessory fixture removably coupled with the body of the workpiece frame to locate the workpiece frame between the base fixture and the accessory fixture. The workpiece frame may be repositionable and relocatable on the base fixture in the at least two different orientations.

In some embodiments, the frame locator may include a body-locating assembly and a pin. The body-locating assembly may extend through the body of the workpiece frame and into the accessory fixture and the base fixture in a first direction. The pin may extend into the base fixture and into the body-locating assembly in a second direction perpendicular to the first direction to fix the body-locating assembly in position relative to the base fixture.

In some embodiments, the body of the workpiece frame may be formed to include a through hole extending therethrough in the first direction and sized to receive the body-locating assembly therein. The body-locating assembly may include a plug located in the through hole of the body and a sleeve extending into the plug and into the base fixture to interconnect the workpiece frame and the base fixture. The sleeve may be formed to include a sleeve hole extending therethrough in the first direction and a groove extending into the sleeve toward the sleeve hole in the second direction. The groove may be sized to receive a portion of the pin therein to fix the body-locating assembly in position relative to the base fixture.

In some embodiments, the frame locator may further include a fastener that extends through the accessory fixture and into the body-locating assembly in the first direction to fix the accessory fixture in position relative to the workpiece frame. The body of the workpiece frame may be formed to define a through hole extending therethrough in the first direction. The base fixture may be formed to define a first hole extending into the base fixture in the first direction. The accessory fixture may be formed to define a hole extending therethrough in the first direction. The through hole of the body, the first hole of the base fixture, and the hole of the accessory fixture may be aligned with one another to receive the body-locating assembly therein.

In some embodiments, the body-locating assembly may include a sleeve located in and extending between the through hole of the body and the first hole of the base fixture and a screw located in and extending between the hole of the accessory fixture, the through hole of the body, and the first hole of the base fixture. The base fixture may be further formed to define a second hole extending into the base fixture in the second direction. The second hole may open into the first hole of the base fixture.

In some embodiments, the sleeve may be formed to include a sleeve hole extending therethrough in the first direction and a groove extending into the sleeve toward the sleeve hole in the second direction. The screw may be received in the sleeve hole of the sleeve and the pin may extend into the second hole of the base fixture and through the groove of the sleeve.

According to another aspect of the present disclosure, a machine tool system may comprise a workpiece, a machine, and a workpiece frame. The machine may be configured to modify the workpiece. The machine may include a tool configured to support the workpiece and a shaft spaced apart from the tool along a first axis and configured to move along the first axis relative to the tool to modify the workpiece. The workpiece frame may be repositionable and relocatable on the tool in at least two different orientations to support the workpiece in the at least two different orientations relative to the first axis during modification of the workpiece so that different sides of the workpiece are modified without requiring removal of the workpiece from the workpiece frame. The workpiece frame may include a body configured to be coupled to the tool and defining a workpiece-receiving space therein and a frame locator arranged outside of the workpiece-receiving space and extending away from the body into contact with the tool to position the workpiece frame relative to the tool so that the workpiece is properly aligned with the shaft in the at least two different orientations.

In some embodiments, the frame locator may include a body-locating assembly and a pin. The body-locating assembly may extend through the body of the workpiece frame and into the tool in a first direction. The pin may extend into the tool and into the body-locating assembly in a second direction perpendicular to the first direction to fix the body-locating assembly in position relative to the tool thereby blocking rotating of the body-locating assembly and the workpiece frame relative to the tool.

In some embodiments, the body of the workpiece frame may be formed to include a through hole extending therethrough in the first direction and sized to receive the body-locating assembly therein. The body-locating assembly may include a plug located in the through hole of the body and a sleeve extending into the plug and into the tool to interconnect the workpiece frame and the tool. The sleeve may be formed to include a sleeve hole extending therethrough in the first direction and a groove extending into the sleeve toward the sleeve hole in the second direction. The groove may be sized to receive a portion of the pin therein to fix the body-locating assembly in position relative to the tool.

In some embodiments, the tool may include a base fixture coupled with a frame of the machine to locate the workpiece relative to the shaft and an accessory fixture removably coupled with the workpiece frame to locate the workpiece frame between the base fixture and the accessory fixture. The workpiece frame may be repositionable and relocatable on the base fixture in the at least two different orientations. The body-locating assembly may extend through the body of the workpiece frame and into both of the base fixture and the accessory fixture. The pin may extend into the base fixture and the body-locating assembly to fix the body-locating assembly in position relative to the base fixture.

In some embodiments, the frame locator may further include a fastener that extends through the accessory fixture and into the body-locating assembly in the first direction to fix the accessory fixture in position relative to the workpiece frame. The body of the workpiece frame may be formed to define a through hole extending therethrough in the first direction. The base fixture may be formed to define a first hole extending into the base fixture in the first direction. The accessory fixture may be formed to define a hole extending therethrough in the first direction. The through hole of the body, the first hole of the base fixture, and the hole of the accessory fixture may be aligned with one another to receive the body-locating assembly therein.

In some embodiments, the body-locating assembly may include a sleeve located in and extending between the through hole of the body and the first hole of the base fixture and a screw located in and extending between the hole of the accessory fixture, the through hole of the body, and the first hole of the base fixture. The base fixture may be further formed to define a second hole extending into the base fixture in the second direction. The second hole may open into the first hole of the base fixture. The sleeve may be formed to include a sleeve hole extending therethrough in the first direction and a groove extending into the sleeve toward the sleeve hole in the second direction. The screw may be received in the sleeve hole of the sleeve and the pin may extend into the second hole of the base fixture and through the groove of the sleeve.

These and other features of the present disclosure will become more apparent from the following description of the illustrative embodiments.

### BRIEF DESCRIPTION OF THE DRAWINGS

FIG. 1 is a diagrammatic view of a machine tool system including a workpiece frame removably coupled to a base fixture of a tool of a machine in a first position, the workpiece frame supports a workpiece thereon in a first orientation relative to a shaft of the machine that modifies a first side of the workpiece by moving along a first axis;

FIG. 2 is a diagrammatic view of the machine tool system of FIG. 1 showing the workpiece frame removably coupled to the base fixture in a second position, the workpiece frame supports the workpiece thereon in a second orientation relative to the shaft of the machine that modifies the workpiece by moving along the first axis, the workpiece frame allowing for movement of the workpiece between the first and second orientations without requiring removal of the workpiece from the workpiece frame;

FIG. 3 is a perspective view of a portion of the machine tool system of FIG. 1 showing that the workpiece frame includes a body that defines a workpiece-receiving space therein and a workpiece locator that extends from the body into the workpiece-receiving space to position the workpiece relative to the body;

FIG. 4 is an exploded view of a portion of the machine tool system of FIG. 3 showing the workpiece and the workpiece frame;

FIG. 5 is a back elevation view of a portion of the machine tool system of FIG. 3 showing the workpiece and the workpiece frame;

FIG. 6 is a front elevation view of a portion of the machine tool system of FIG. 3 showing the workpiece and the workpiece frame;

FIG. 7 is an exploded diagrammatic view of the machine tool system of FIG. 1 showing that the machine tool system includes the base fixture and an accessory fixture with the workpiece frame located between the base fixture and the accessory fixture, and further suggesting that a frame locator extends through the accessory fixture, the workpiece frame, and the base fixture to couple the components together during machining of the workpiece;

FIG. 8 is an exploded view of the machine tool system of FIG. 1 showing, from top to bottom, the accessory fixture that is adapted to provide fluid to the workpiece during machining of the workpiece, the workpiece frame configured to be coupled with the base fixture, and the base fixture, and further showing that the workpiece frame includes the frame locator that extends between the accessory fixture, the body of the workpiece frame, and the base fixture to locate and position the components relative to one another and to the shaft of the machine;

FIG. 9 is an exploded view similar to FIG. 8 showing that the frame locator includes a body-locating assembly that extends through the workpiece frame and into contact with the accessory fixture and the base fixture, a pin that extends into the base fixture, and a fastener that extends into the accessory fixture;

FIG. 10 is an exploded view similar to FIG. 9 showing that the pin of the frame locator extends into the base fixture and the body-locating assembly to position and locate the workpiece frame relative to the base fixture;

FIG. 11 is a perspective view of the machine tool system of FIG. 1 showing that the fastener extends into the accessory fixture and into contact with the body-locating assembly to position and locate the accessory fixture relative to the workpiece frame;

FIG. 12 is a section view of the machine tool system of FIG. 11 showing that the body-locating assembly includes a plug extending through the workpiece frame, a sleeve extending between the plug and the base fixture, and a screw extending between the accessory fixture, the workpiece frame, and the base fixture;

FIG. 13 is an enlarged view of FIG. 12 showing that the pin of the frame locator extends into the base fixture and through the sleeve of the body-locating assembly; and

FIG. 14 is another section view of the machine tool system of FIG. 11 showing that the fastener of the frame locator extends through the accessory fixture and into the screw of the body-locating assembly.

### DETAILED DESCRIPTION

For the purposes of promoting an understanding of the principles of the disclosure, reference will now be made to a number of illustrative embodiments illustrated in the drawings and specific language will be used to describe the same.

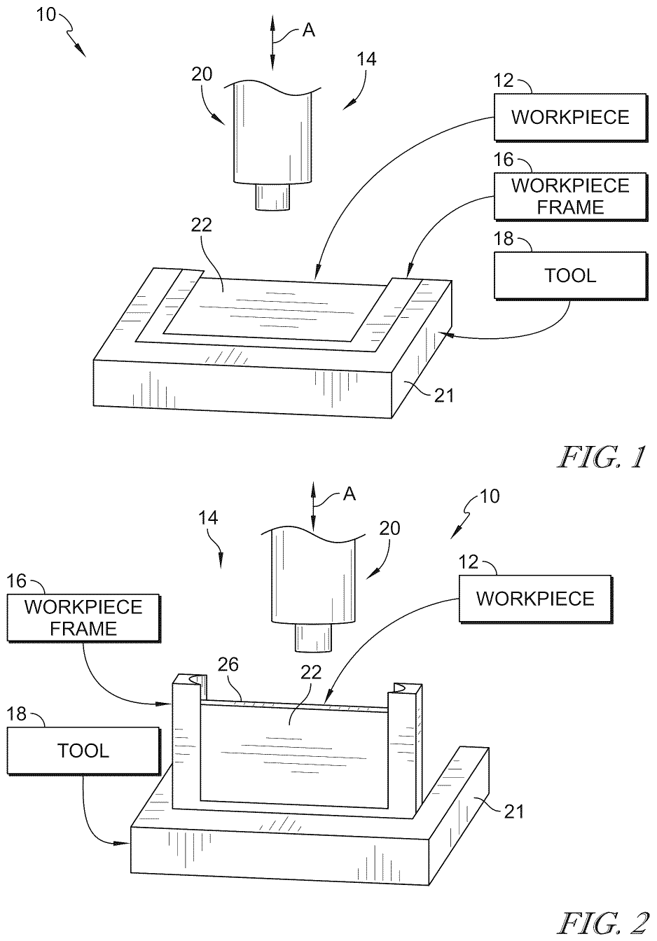

A machine tool system 10 includes a workpiece 12, a machine 14, and a workpiece frame 16, as shown in FIGS. 1 and 2. In illustrative embodiments, the workpiece 12 is a thin-walled three-dimensional workpiece. The machine 14 is configured to modify the workpiece 12. The workpiece frame 16 supports the workpiece 12 and is repositionable and relocatable on the machine 14 in different positions. The workpiece 12 remains stationary relative to the workpiece frame 16 such that repositioning of the workpiece frame 16 on the machine 14 also repositions the workpiece 12 so that different sides of the workpiece 12 may be modified by the machine 14 without requiring removal of the workpiece 12 from the workpiece frame 16.

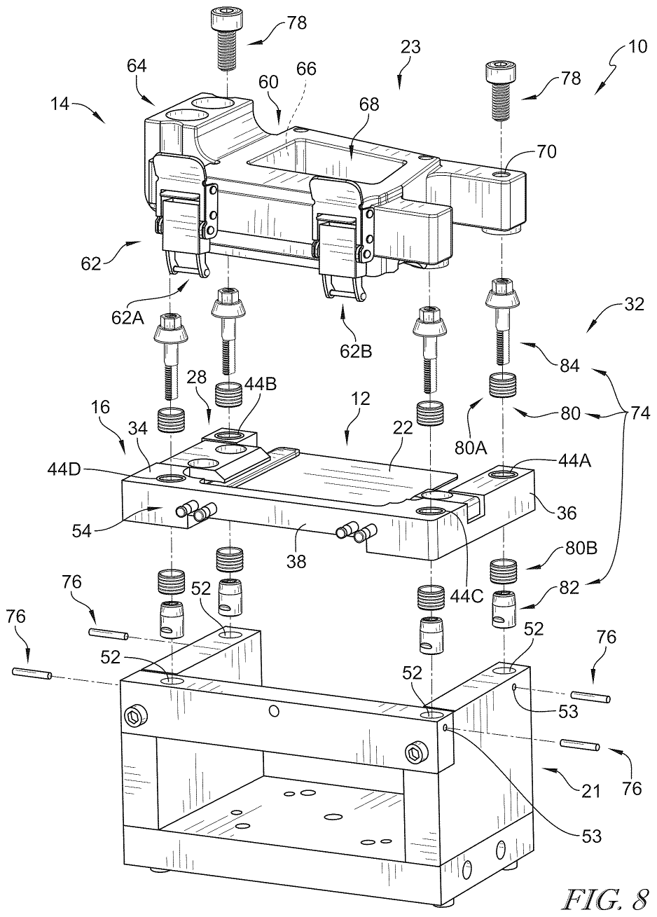

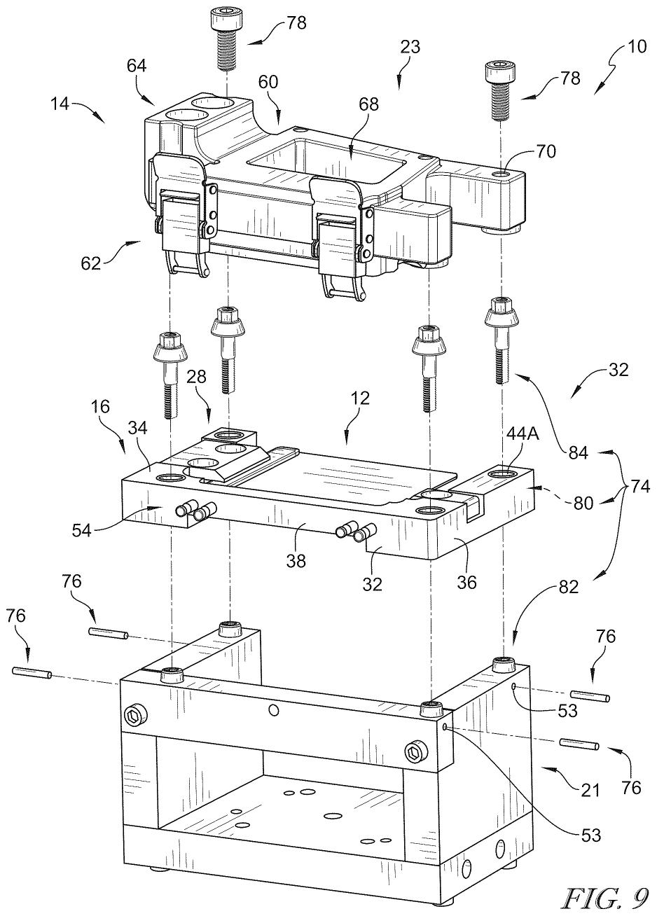

The machine 14 includes a tool 18 and a shaft 20, as shown in FIGS. 1 and 2. The tool 18 supports the workpiece frame 16, and thus, the workpiece 12, relative to the shaft 20. The shaft 20 is spaced apart from the tool 18 and moves along a first axis A to modify the workpiece 12. The tool 18 includes a base fixture 21 for fixing the workpiece frame 16 to the machine 14, as shown in FIG. 8. The tool 18 may further include accessory fixtures 23, such as the accessory fixture 23 shown in FIGS. 7-14.

The workpiece frame 16 is configured to removably couple with the base fixture 21 and is movable between at least a first orientation, as shown in FIG. 1, and a second orientation, as shown in FIG. 2. In the illustrative embodiment shown in FIGS. 1 and 2, the second orientation is offset by about 90 degrees compared to the first orientation. In other embodiments, the second orientation is offset by 180 degrees compared to the first orientation. In other embodiments, the second orientation may be offset from the first orientation by any suitable rotation angle and about any suitable axis through the workpiece frame 16.

In some embodiments, the machine 14 is capable of pulsed electrochemical machining (PECM). In such an embodiment, the shaft 20 or bit attached to the shaft 20 may be referred to as a cathode. To modify the workpiece 12, the shaft 20 moves toward the workpiece 12 and oscillates along the first axis A, but does not contact the workpiece 12. Once the shaft 20 is adjacent the workpiece 12 to form a gap therebetween, an electrolyte is injected into the gap. The electrolyte acts as an electron transfer medium to facilitate anodic dissolution of the material of the workpiece 12 adjacent the shaft 20. In some embodiments, the electrolyte may be a salt-based solution. The electrolyte allows electrical current to flow between the shaft 20 and the workpiece 12. Any by-products, such as, for example, metal hydroxides or hydrogen gas, of the electrochemical process are then flushed away by the electrolyte. The shaft 20 illustratively has a shape inverse to that of the desired workpiece 12 shape. In some embodiments, the shaft 20 may comprise titanium, stainless steel, copper, or any other suitable current carrying material.

Because PECM is a non-contact and non-thermal process, the workpiece 12 is not subjected to thermal or mechanical stresses. Additionally, because PECM is a non-contact and non-thermal process, the shaft 20 is not typically consumed or worn during the process of machining. In other embodiments, the machine 14 performs other subtractive or additive processes and may contact the workpiece 12. For example, the machine 14 may provide turning, milling, drilling, grinding, cutting, laser cutting, waterjet cutting, electrical discharge machining, plasma cutting, laser deposition, 3D printing, etc.

In some embodiments, the machine 14 is a single axis machine 14. In other words, the shaft 20 of the machine 14 only moves along the first axis A. Thus, to modify different sides of the workpiece 12, the workpiece 12 is repositioned such that the different sides may be modified by the shaft 20 moving along the first axis A. However, the workpiece 12 may be relatively thin and easily distorted or non-repositionable in conventional fixtures and any repositioning of the workpiece 12 itself may distort the workpiece 12. The workpiece frame 16 and the tool 18 of the present disclosure provides the ability to reposition the workpiece 12 without removal of the workpiece 12 from the workpiece frame 16. In this way, the workpiece frame 16 is repositioned, which also repositions the workpiece 12, while allowing the workpiece 12 to remain stationary relative to the workpiece frame 16.

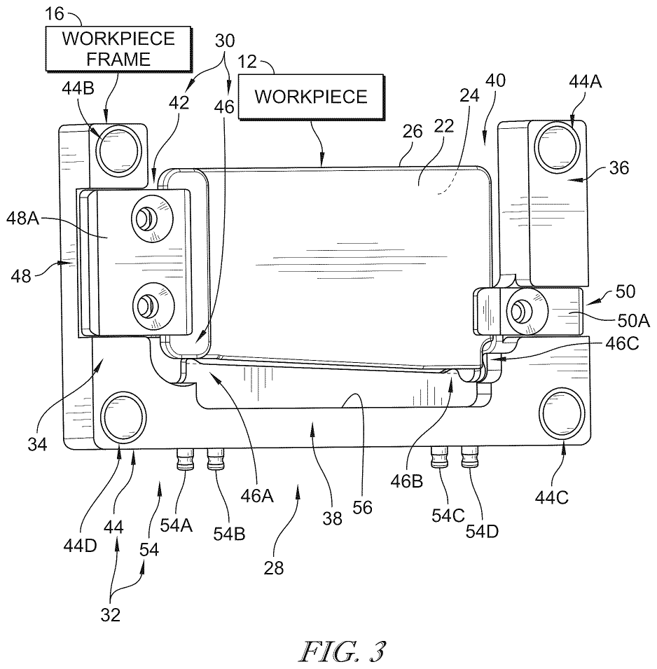

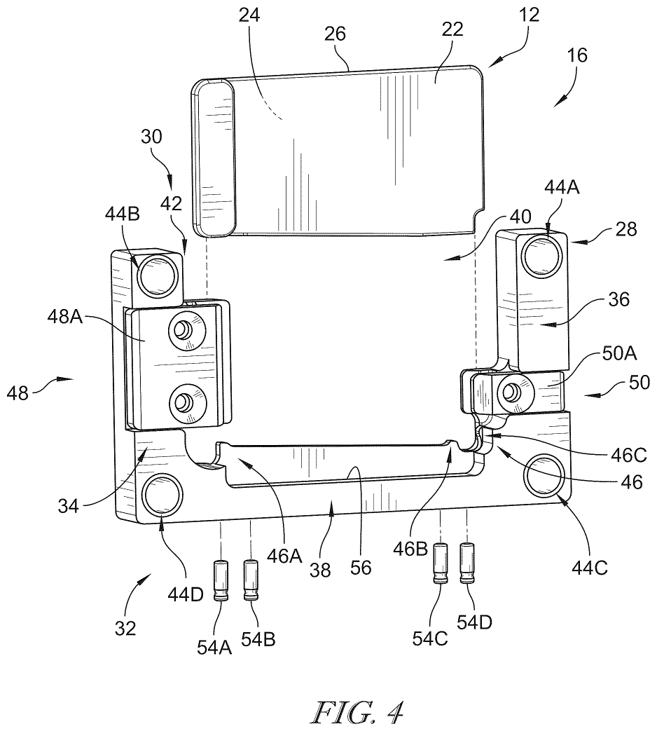

The workpiece 12 is illustratively a thin-walled three-dimensional workpiece, as shown in FIGS. 3 and 4. The workpiece 12 is three-dimensional, meaning that the workpiece 12 has a length, a width, and a height. In some embodiments, the workpiece 12 may be thin-walled. The workpiece 12 may have a size of about six inches by about eight inches. The workpiece 12 includes a first side 22, a second side 24 opposite the first side 22, and an edge 26 that extends between and interconnects the first side 22 and the second side 24. The first side 22, the second side 24, and the edge 26 may each be modified by the machine 14 by repositioning the workpiece frame 16.

In some embodiments, the workpiece 12 may be used in a gas turbine engine. For example, the workpiece 12 may form a part of a vane or a blade of a gas turbine engine. The workpiece 12 may provide a coversheet for a pressure side and/or a suction side of a vane or a blade.

As shown in FIGS. 1 and 2, the workpiece frame 16 is repositionable and relocatable on the tool 18 in different positions to support the workpiece 12 in different orientations relative to the first axis A during modification of the workpiece 12 so that different sides of the workpiece 12 are modified without requiring removal of the workpiece 12 from the workpiece frame 16. As shown in FIG. 1, the workpiece frame 16 is in a first position relative to the base fixture 21 of the tool 18 and the shaft 20. While the workpiece frame 16 is in the first position, the workpiece 12 is in a first orientation relative to the first axis A. In the first orientation of the workpiece 12, the first side 22 of the workpiece 12 is modified. The first orientation of the workpiece 12 may be an orientation with the first side 22 facing upwardly toward the shaft 20.

As shown in FIG. 2, the workpiece frame 16 is in a second position relative to the base fixture 21 and the shaft 20. While the workpiece frame 16 is in the second position, the workpiece 12 is in a second orientation relative to the first axis A. In the second orientation of the workpiece 12, the edge 26 of the workpiece 12 is modified. The second orientation of the workpiece 12 may be an orientation with the edge 26 facing upwardly toward the shaft 20.

Though two different positions of the workpiece frame 16 and two different orientations of the workpiece 12 are shown, it will be understood that additional positions and orientations may be used. For example, the workpiece frame 16 may be moved to a third position relative to the base fixture 21 and the shaft 20. While the workpiece frame 16 is in the third position, the workpiece 12 is in a third orientation relative to the first axis A. In the third orientation of the workpiece 12, the second side 24 of the workpiece 12 is modified, as an example. The third orientation of the workpiece 12 may be an orientation with the second side 24 facing upwardly toward the shaft 20. In other words, the third position may be a flipped position of the first position. To move the workpiece frame 16 between each position, the workpiece frame 16 may be removed from the base fixture 21 and reattached to the base fixture 21 in a different position.

The workpiece frame 16 includes a body 28, a workpiece locator 30, and a frame locator 32, as shown in FIGS. 3 and 4. The body 28 is configured to be coupled to the base fixture 21 in the different positions. The workpiece locator 30 contacts the workpiece 12 to position the workpiece 12 relative to the body 28. The frame locator 32 contacts the accessory fixture 23 and the base fixture 21 to position the body 28 relative to the accessory fixture 23 and the base fixture 21. Precise positioning of the workpiece 12 relative to the body 28 and the body 28 relative to the tool 18 ensures that the workpiece 12 is properly aligned with the shaft 20 in the different orientations of the workpiece 12.

In illustrative embodiments, the body 28 is C-shaped, as shown in FIG. 3. The C-shaped body 28 provides open access to the edge 26 of the workpiece 12, as shown in FIGS. 2 and 3. This open access allows the machine 14 to more readily modify the workpiece 12. The C-shaped body 28, thus, provides access to three sides of the workpiece 12, including the first side 22, the second side 24, and the edge 26. In some embodiments, the body 28 may not be C-shaped.

The body 28 includes a first arm 34, a second arm 36, and a third arm 38, as shown in FIG. 3. The first arm 34 and the second arm 36 are spaced apart from one another, and the third arm 38 extends between and interconnects first terminal ends of the first arm 34 and the second arm 36. Because the body 28 is C-shaped, second terminal ends of the first arm 34 and the second arm 36 are not interconnected, as shown in FIG. 3. The first arm 34, the second arm 36, and the third arm 38 cooperate to define a workpiece-receiving space 40.

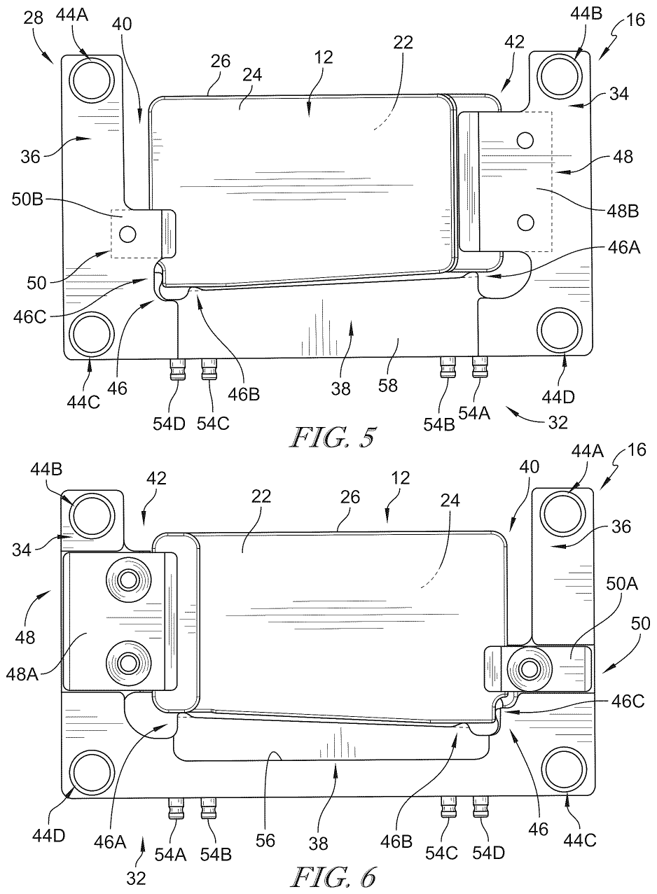

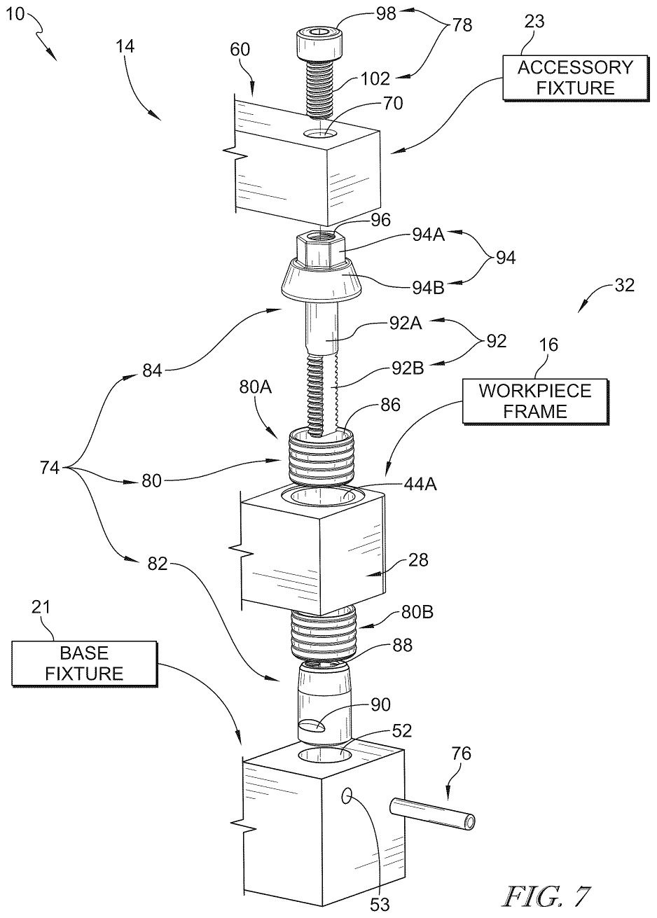

Illustratively, the arms 34, 36, 38 each define planar surfaces, as shown in FIGS. 5 and 6. For example, a front surface of each arm 34, 36, 38, as shown in FIG. 6, is substantially planar. As another example, a back surface of each arm 34, 36, 38, as shown in FIG. 5, is substantially planar. The substantially planar surfaces act as datums for positioning the workpiece frame 16 on the base fixture 21. The datums help to ensure proper alignment of the body 28 with the tool 18.

The workpiece locator 30 includes a clamp 42 and a plurality of workpiece locating protrusions 46, as shown in FIGS. 3 and 4. The clamp 42 is coupled to the body 28 and extends into the workpiece-receiving space 40 to couple with the workpiece 12. The plurality of workpiece locating protrusions 46 extends into the workpiece-receiving space 40 from the body 28 to contact and locate the workpiece 12.

The clamp 42 illustratively includes a first clamp member 48 and a second clamp member 50 spaced apart from the first clamp member 48, as shown in FIGS. 3-6. The first clamp member 48 extends inwardly from the first arm 34 of the body 28 toward the second arm 36. The first clamp member 48 includes a first clamp plate 48A and a second clamp plate 48B spaced apart from the first clamp plate 48A to locate a first end of the workpiece 12 between the first clamp plate 48A and the second clamp plate 48B.

The second clamp member 50 extends inwardly from the second arm 36 of the body 28 toward the first arm 34 and the first clamp member 48, as shown in FIG. 3. The second clamp member 50 includes a third clamp plate 50A and a fourth clamp plate 50B spaced apart from the third clamp plate 50A to locate a second end of the workpiece 12 between the third clamp plate 50A and the fourth clamp plate 50B. The first clamp member 48 and the second clamp member 50 support opposing ends of the workpiece 12 to hold the workpiece 12 in a stationary position relative to the body 28, as suggested in FIGS. 5 and 6.

The first arm 34, the second arm 36, the third arm 38, the second clamp plate 48B, and the fourth clamp plate 50B are integrally formed as a single one-piece component, as shown in FIG. 5. The second clamp plate 48B and the fourth clamp plate 50B are illustratively immovable surfaces integral to the body 28. The workpiece 12 rests on these immovable clamp plates 48B, 50B. In some embodiments, the first clamp plate 48A is moveable relative to the first arm 34 and the second clamp plate 48B, and the third clamp plate 50A is moveable relative to the second arm 36 and the fourth clamp plate 50B.

The workpiece 12 is located in the workpiece-receiving space 40, as shown in FIG. 3. The first end of the workpiece 12 is clamped between the first clamp plate 48A and the second clamp plate 48B, and the second end of the workpiece 12 is clamped between the third clamp plate 50A and the fourth clamp plate 50B to couple the workpiece 12 to the body 28.

The plurality of workpiece locating protrusions 46 extends into the workpiece-receiving space 40 from the body 28 to contact the workpiece 12 and to locate the workpiece 12 within the workpiece-receiving space 40 relative to the body 28, as shown in FIGS. 5 and 6. The plurality of workpiece locating protrusions 46 illustratively includes a first protrusion 46A, a second protrusion 46B, and a third protrusion 46C. The first protrusion 46A extends from the third arm 38 of the body 28 into the workpiece-receiving space 40. The second protrusion 46B extends from the third arm 38 of the body 28 into the workpiece-receiving space 40 and is spaced apart from the first protrusion 46A along the third arm 38. The third protrusion 46C extends from the second arm 36 of the body 28 into the workpiece-receiving space 40.

The first and second protrusions 46A, 46B contact an edge of the workpiece 12 opposite the edge 26, while the third protrusion 46C contacts another edge of the workpiece 12, as shown in FIGS. 5 and 6. The protrusions 46A, 46B, 46C ensure that the workpiece 12 is properly positioned within the workpiece-receiving space 40 of the body 28. For example, the first and second protrusions 46A, 46B ensure that the workpiece 12 is properly positioned within the workpiece-receiving space 40 relative to the third arm 38. The third protrusion 46C ensures that the workpiece 12 is properly positioned within the workpiece-receiving space 40 relative to the first and second arms 34, 36 of the body 28. In some embodiments, the protrusions 46A, 46B, 46C are integrally formed with the body 28.

The frame locator 32 is located outside of the workpiece-receiving space 40 of the body 28, as shown in FIGS. 3 and 4. The frame locator 32 ensures that the body 28 is properly positioned on the tool 18, thereby ensuring that the workpiece 12 is properly positioned relative to the tool 18 and the shaft 20.

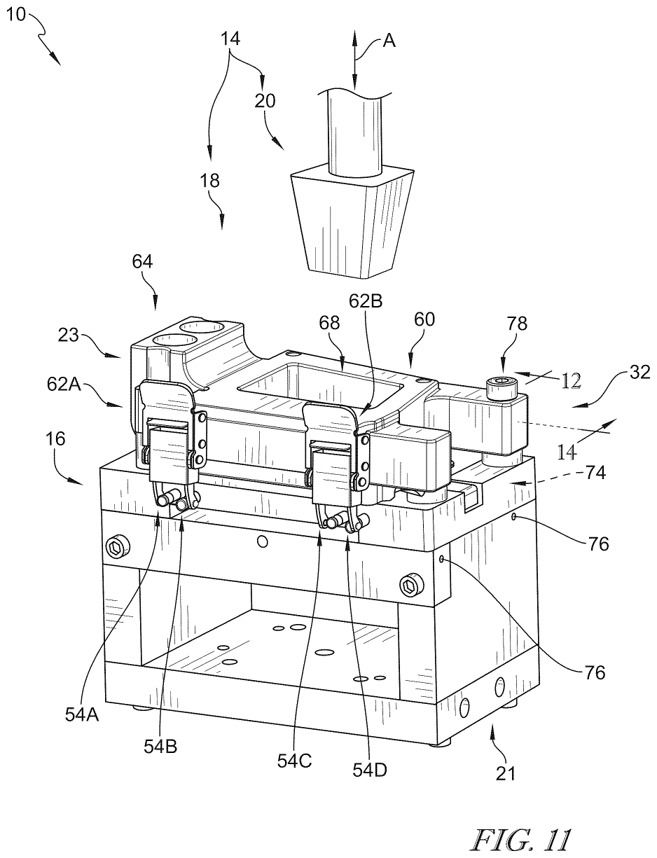

The frame locator 32 illustratively includes a plurality of holes 44 and a plurality of pins 54 configured to couple the workpiece frame 16 to the base fixture 21 and/or accessory fixture 23 of the tool 18, as shown in FIG. 11. The plurality of holes 44 is used to couple the body 28 to the base fixture 21. In illustrative embodiments, the plurality of holes 44 extends through the body 28 in a first direction, as shown in FIG. 11. The plurality of pins 54 is configured to couple the accessory fixture 23 of the machine 14 to the workpiece frame 16, as shown in FIG. 11. In the illustrative embodiment, the accessory fixture 23 includes a flow block that couples with the workpiece frame 16 to direct the electrolyte through the gap formed between the workpiece 12 and the shaft 20. Though one accessory fixture 23 is shown, multiple different accessory fixtures may be used during the machining process depending on the orientation of the workpiece 12.

In some embodiments, the plurality of holes 44 includes a first hole 44A, a second hole 44B, a third hole 44C, and a fourth hole 44D, as shown in FIG. 3. The first hole 44A extends through the second arm 36, and the second hole 44B extends through the first arm 34. The third and fourth holes 44C, 44D extend through the third arm 38. The holes 44A, 44B, 44C, 44D are located at the four corners of the body 28, as shown in FIG. 3.

The plurality of pins 54 is coupled to and extends outwardly away from the third arm 38 of the body 28, as shown in FIGS. 3, 5, and 6. The plurality of pins 54 illustratively includes a first pin 54A, a second pin 54B, a third pin 54C, and a fourth pin 54D. Though shown and described as including four pins 54, additional pins or fewer pins are contemplated.

Each of the pins 54A, 54B, 54C, 54D extends outwardly away from the workpiece-receiving space 40, as shown in FIGS. 5 and 6. Each of the pins 54A, 54B, 54C, 54D extends outwardly from the third arm 38 of the body 28 beyond the surface of the third arm 38 that faces away from the workpiece-receiving space 40.

Illustratively, each of the pins 54A, 54B, 54C, 54D is received in a corresponding hole formed in the body 28, as suggested in FIG. 4. Each of the pins 54A, 54B, 54C, 54D is received in the corresponding hole to extend outwardly beyond the surface of the third arm 38. Each of the pins 54A, 54B, 54C, 54D extend parallel with each other.

In some embodiments, the body 28 may be formed to include a first pocket 56 and a second pocket 58, as shown in FIGS. 5 and 6. The pockets 56, 58 are illustratively formed as recesses in the third arm 38. The pockets 56, 58 are formed on opposing sides of the third arm 38. Depending on the type of the machine 14, the pockets 56, 58 may provide tool clearance. The pockets 56, 58 may also act as locating features for a portion of the machine 14, such as the accessory fixture 23.

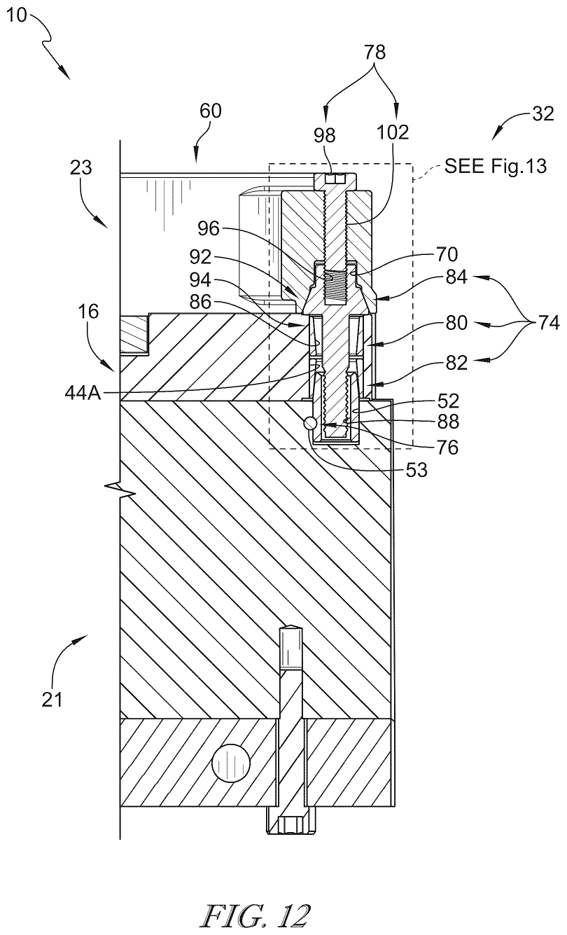

An exemplary base fixture 21 is shown in FIGS. 8-11. In some embodiments, the base fixture 21 is configured to be coupled with a frame of the machine 14. The workpiece frame 16 is removably coupled with the base fixture 21, and the base fixture 21 is fixed with the frame of the machine 14 so that the workpiece frame 16 is held in a fixed position relative to the shaft 20. The base fixture 21 is formed to include a plurality of first holes 52 extending into the base fixture 21 in the first direction, as shown in FIGS. 7 and 8. The base fixture 21 is also formed to include a plurality of second holes 53 extending into the base fixture 21 in a second direction that is perpendicular to the first direction. Each of the plurality of second holes 53 opens into a corresponding one of the plurality of first holes 52, as shown in FIG. 12.

The accessory fixture 23 couples with one or both of the workpiece frame 16 and the workpiece 12 to provide additional support, guides, fluid channels, or other machining assistance. In the illustrative embodiment, the accessory fixture 23 directs the electrolyte over the workpiece 12 during the machining operation and provides a guide for the shaft 20. The accessory fixture 23 includes a fixture body 60 and at least one latch clamp 62 coupled with the fixture body 60, as shown in FIG. 8. In the illustrative embodiment, the at least one latch clamp 62 includes a first latch clamp 62A and a second latch clamp 62B. The latch clamps 62 are configured to selectively engage with the pins 54 of the workpiece frame 16 to urge the workpiece frame 16 toward the accessory fixture 23 and couple the workpiece frame 16 with the tool 18. The first latch clamp 62A is configured to engage the pins 54A, 54B and the second latch clamp 62B is configured to engage the pins 54C, 54D when the workpiece frame 16 is in the first orientation, as suggested in FIG. 8. If the same accessory fixture 23 is used when the workpiece frame 16 is flipped over, the first latch clamp 62A is configured to engage the pins 54C, 54D and the second latch clamp 62B is configured to engage the pins 54A, 54B.

In the illustrative embodiment of the accessory fixture 23, the fixture body 60 is formed to include a fluid inlet 64 and fluid passages 66 for directing the electrolyte around and over the workpiece 12 during operation of the machine 14. The fixture body 60 is formed to define a guide passage 68 that extends entirely through the fixture body 60 to provide the shaft 20 of the machine 14 access to the surface (i.e., the first side 22) of the workpiece 12, as suggested in FIG. 11.

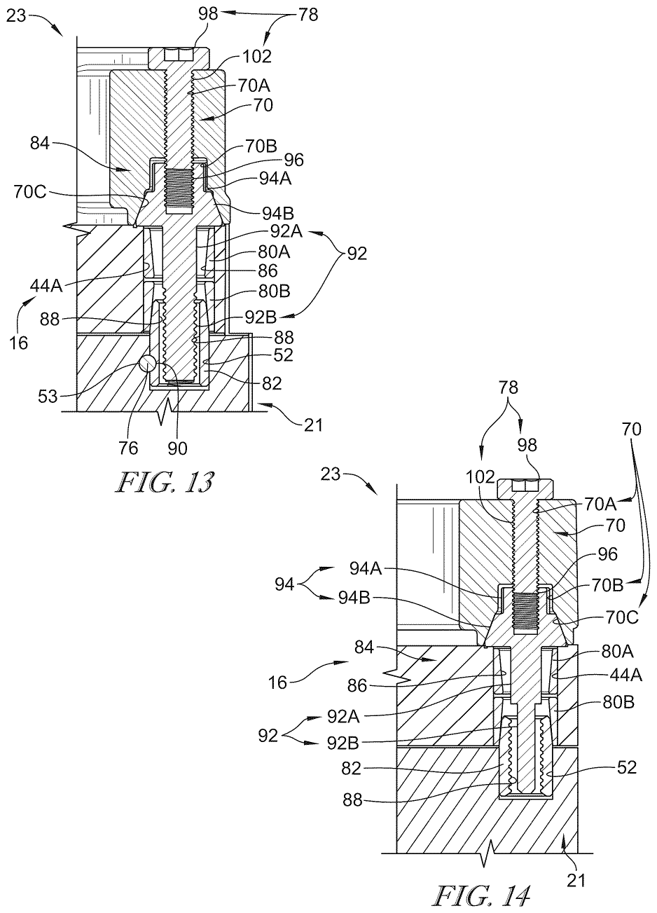

The fixture body 60 of the accessory fixture 23 is formed to define a plurality of holes 70 extending therethrough in the first direction, as shown in FIG. 8. At least two of the plurality of holes 70 illustratively defines a first portion 70A, a second portion 70B, and a third portion 70C, as shown in FIGS. 13 and 14. The second portion 70B is located between the first portion 70A and the third portion 70C. The first portion 70A has a smaller diameter than the second and third portions 70B, 70C. The third portion 70C is tapered so as to have an increasing diameter as the third portion 70C extends away from the second portion 70B.

Another accessory fixture (not shown) may also be used to machine the second side 24 of the workpiece 12 as compared to using the accessory fixture 23. However, in some operations, the same accessory fixture 23 may be used when the workpiece frame 16 is flipped and the second side 24 is machined.

Turning back to the frame locator 32, the frame locator 32 further includes a body-locating assembly 74, a pin 76, and a fastener 78, as shown in FIGS. 7 and 8. The body-locating assembly 74 extends along the first axis A and is arranged outside of the workpiece-receiving space 40 of the body 28. The body-locating assembly 74 extends away from the body 28 into contact with the base fixture 21 and the accessory fixture 23 to position the workpiece frame 16 relative to the base fixture 21 and the accessory fixture 23 so that the workpiece 12 is properly aligned with the shaft 20 in the at least two different orientations.

The body-locating assembly 74 extends through the body 28 of the workpiece frame 16, as suggested in FIGS. 7 and 8. The pin 76 extends into the base fixture 21 and the body-locating assembly 74. The fastener 78 extends into the accessory fixture 23 and the body-locating assembly 74.

As shown in FIG. 8, the frame locator 32 may include a plurality of body-locating assemblies 74, a plurality of pins 76, and a plurality of fasteners 78. For example, the frame locator 32 may include a body-locating assembly 74 and a pin 76 for each hole 44A, 44B, 44C, 44D of the workpiece frame 16. Thus, in the illustrative embodiment, the frame locator 32 may include four body-locating assemblies 74 and four pins 76. The C-shaped body 28 may distort in free state, and positioning the workpiece 12 on the C-shaped body 28 may also lead to distortion of the C-shaped body 28. Locating the accessory fixture 23 and the base fixture 21 relative to the workpiece frame 16 at four locations improves the accuracy of positioning of the workpiece 12 relative to the shaft 20. In some embodiments, one location is used (i.e., the hole 44A). In some embodiments, two locations are used (i.e., the holes 44A, 44B). In some embodiments, three locations are used (i.e., the holes 44A, 44B, 44C). In some embodiments, four locations are used (i.e., the holes 44A, 44B, 44C, 44D).

As shown in FIG. 8, while four body-locating assemblies 74 and four pins 76 are used, two fasteners 78 may be used. Specifically, the fasteners 78 are used in the holes 44A, 44B opposite the latch clamps 62A, 62B of the accessory fixture 23. In some embodiments, the latch clamps 62A, 62B and the plurality of pins 54 may be omitted and, instead, four fasteners 78 may be used to secure the accessory fixture 23 to the workpiece frame 16.

Though shown with four body-locating assemblies 74, four pins 76, and two fasteners 78, one of each will be described herein. The description of one body-locating assembly 74, one pin 76, and one fastener 78 applies to the other body-locating assemblies 74, the other pins 76, and the other fastener 78.

The body-locating assembly 74 extends through the hole 44A of the body 28 of the workpiece frame 16 and into both of the accessory fixture 23 and the base fixture 21 in the first direction, as shown in FIGS. 9 and 12. The body-locating assembly 74 includes a plug 80, a sleeve 82, and a screw 84, as shown in FIG. 7. The plug 80 is illustratively located entirely within the hole 44A of the body 28 of the workpiece frame 16, as shown in FIG. 12. The sleeve 82 extends between the plug 80 and the base fixture 21. The screw 84 extends between the sleeve 82 and the accessory fixture 23.

The plug 80 is formed to define a through hole 86 extending entirely therethrough in the first direction, as shown in FIGS. 12-14. In illustrative embodiments, the plug 80 includes a first plug 80A and a second plug 80B spaced apart from the first plug 80A along the first direction. The first plug 80A is inserted into the hole 44A from above the workpiece frame 16 to a specific depth, and the second plug 80B is inserted into the hole 44A from below the workpiece frame 16 to the specific depth, as suggested in FIG. 7. In some embodiments, the plugs 80A, 80B are formed to define ridges on an outer surface thereof, as shown in FIGS. 7 and 8. The ridges act as interference features to secure the plugs 80A, 80B in the hole 44A.

The sleeve 82 extends into the first hole 52 of the base fixture 21, as shown in FIG. 9. In some embodiments, the sleeve 82 is pressed into the first hole 52 to a specific depth such that the sleeve 82 does not move out of the first hole 52 without manipulation from an operator. As shown in FIG. 12, the sleeve 82 extends into the through hole 86 of the plug 80 thereby interconnecting the base fixture 21 and the workpiece frame 16.

The sleeve 82 is formed to define a sleeve hole 88 extending entirely therethrough in the first direction and a groove 90 extending into the sleeve 82 toward the sleeve hole 88 in a second direction, as shown in FIGS. 7, 8, and 13.

As shown in FIGS. 13 and 14, the sleeve 82 is partially threaded. Two opposing inner surfaces of the sleeve 82 are threaded, as shown in FIG. 14, while the remaining two opposing inner surfaces are non-threaded, as shown in FIG. 13. In some embodiments, an entirety of the inner surface of the sleeve 82 is threaded. In some embodiments, an entirety of the inner surface of the sleeve 82 is non-threaded.

In some embodiments, the sleeve 82 and the plugs 80A, 80B are formed of different materials. In some embodiments, the sleeve 82 and the plugs 80A, 80B are formed of the same materials and one of the sleeve 82 and the plugs 80A, 80B is coated. For example, one of the sleeve 82 and the plugs 80A, 80B may be coated to improve durability, increase hardness, and provide anti-rust properties.

The screw 84 extends between the base fixture 21 and the accessory fixture 23, as shown in FIG. 12. The screw 84 illustratively includes a body 92 and a head 94 coupled to a terminal end of the body 92. The body 92 includes a first portion 92A and a second portion 92B. The first portion 92A is located between the head 94 and the second portion 92B. Illustratively, the first portion 92A is non-threaded, as shown in FIGS. 13 and 14. In some embodiments, two opposing outer surfaces of the second portion 92B are threaded, as shown in FIG. 13, while the remaining two opposing outer surfaces are non-threaded, as shown in FIG. 14. In some embodiments, the two opposing outer surfaces that are non-threaded are flat (as opposed to rounded), as shown in FIG. 7. The half-threaded second portion 92B (along with the half-threaded inner surface of the sleeve 82) allows the screw 84 to engage and lock with the threads of the sleeve 82 with less than one full turn of the screw 84. For example, a quarter turn of the screw 84 may lock the screw 84 with the sleeve 82. In this way, securing the screw 84 to the sleeve 82 is relatively fast and simple. In some embodiments, an entirety of the second portion 92B is threaded. In some embodiments, an entirety of the second portion 92B is non-threaded.

The head 94 of the screw 84 includes a fastener-receiving hole 96 extending into the head 94 toward the body 92 in the first direction, as shown in FIGS. 13 and 14. The fastener-receiving hole 96 is illustratively threaded. The head 94 of the screw 84 includes a non-tapered portion 94A and a tapered portion 94B, as shown in FIGS. 13 and 14. The non-tapered portion 94A may have a hexagonal shape. The tapered portion 94B is located between the non-tapered portion 94A and the first portion 92A of the body 92. The tapered portion 94B is tapered so as to have an increasing diameter as the tapered portion 94B extends away from the non-tapered portion 94A.

The screw 84 extends through the hole 44A of the workpiece frame 16 and into the first hole 52 of the base fixture 21, as shown in FIG. 12. More specifically, the screw 84 extends through the through hole 86 of the plug 80 and into the sleeve hole 88 of the sleeve 82. In the sleeve hole 88, the threads of the second portion 92B of the body 92 may engage the threads of the sleeve 82 to fix the workpiece frame 16 relative to the base fixture 21 and prevent movement of the workpiece frame 16 relative to the base fixture 21 in the first direction (a vertical direction in FIGS. 13 and 14). Though shown and described as a screw 84, the screw may comprise any suitable fastener.

An inner surface of the tapered portion 94B of the head 94 of the screw 84 engages a surface of the body 28 of the workpiece frame 16 surrounding the hole 44A, as shown in FIGS. 13 and 14. The tapered portion 94B of the head 94 engages the third portion 70C of the hole 70 of the accessory fixture 23, as shown in FIGS. 13 and 14. Engagement of these tapered portions 94B, 70C align the accessory fixture 23 with the workpiece frame 16 so as to prevent movement of the accessory fixture 23 relative to the workpiece frame 16 in a horizontal direction. The non-tapered portion 94A of the head 94 of the screw 84 extends into the second portion 70B of the hole 70 of the accessory fixture 23.

The pin 76 extends into the second hole 53 of the base fixture 21 and into the groove 90 of the sleeve 82, as shown in FIGS. 7 and 13. The pin 76 fixes the sleeve 82 in position relative to the base fixture 21 so that rotation of the sleeve 82, and thus, the workpiece frame 16, relative to the base fixture 21 about the first direction is prevented. Though shown and described as a pin 76, the pin may comprise any suitable fastener.

The fastener 78 extends through the through hole 70 of the accessory fixture 23 and into the screw 84 in the first direction, as shown in FIGS. 12-14. The fastener 78 includes a head 98 and a shaft 102 extending away from the head 98. The head 98 is located on top of the accessory fixture 23, as shown in FIGS. 13 and 14. The shaft 102 of the fastener 78 extends through first portion 70A of the through hole 70 and into the fastener-receiving hole 96 of the screw 84. The shaft 102 is illustratively threaded so that the threads of the shaft 102 mate with the threaded fastener-receiving hole 96 of the screw 84. In this way, the fastener 78 fixes the accessory fixture 23 in position relative to the workpiece frame 16 and prevents movement of the accessory fixture 23 relative to the workpiece frame 16 in the first direction (a vertical direction in FIGS. 13 and 14).

To couple the base fixture 21, the workpiece frame 16, and the accessory fixture 23 to one another, the plugs 80A, 80B may be inserted into the hole 44A of the workpiece frame 16, as suggested in FIGS. 7 and 8. The plugs 80A, 80B may be inserted from opposing sides of the workpiece frame 16 to the same depth. The sleeve 82 may be inserted into the first hole 52 of the base fixture 21 to a specific depth, as suggested in FIG. 9. The pin 76 may be inserted into the second hole 53 of the base fixture 21 and the groove 90 of the sleeve 82 to prevent rotation of the sleeve 82 within the first hole 52.

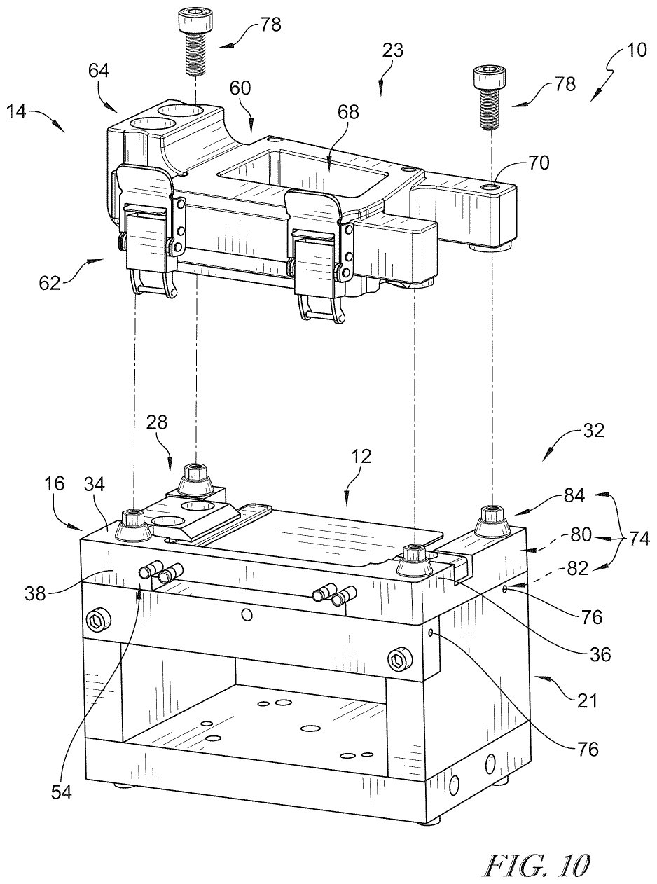

The workpiece frame 16 may then be moved downwardly toward the base fixture 21 so that the sleeve 82 extends into the through hole 86 of the plug 80. The sleeve 82 acts as a secondary datum to locate the workpiece frame 16, and thus, the workpiece 12, relative to the base fixture 21. The screw 84 may be inserted into the through hole 86 of the plug 80 and the through sleeve hole 88 of the sleeve 82, as suggested in FIG. 10. The screw 84 may be torqued so that the threads of the screw 84 mate with the threads of the sleeve 82. The accessory fixture 23 may be positioned on top of the workpiece frame 16 by aligning the through hole 70 of the accessory fixture 23 with the head 94 of the screw 84. The fastener 78 may be inserted into the through hole 70 of the accessory fixture 23 and torqued so that the threads of the fastener 78 mate with the threaded fastener-receiving hole 96 of the screw 84, as suggested in FIG. 11.

After the first side 22 of the workpiece 12 is machined via the shaft 20, the workpiece frame 16 may be flipped 180 degrees over to allow machining of the second side 24 of the workpiece 12. The workpiece frame 16 may be flipped over and used with the same accessory fixture 23, a different accessory fixture or other suitable fixture, the base fixture 21, or a different base fixture. After the workpiece frame 16 is flipped over, the frame locator 32 may be used to couple the base fixture 21, the workpiece frame 16, and the accessory fixture 23 together.

The frame locator 32 allows the workpiece frame 16, and thus the workpiece 12, to be flipped 180 degrees between a first orientation and a second orientation such that both sides 22, 24 of the workpiece 12 may be modified. The frame locator 32 ensures that the workpiece 12 is properly aligned with the shaft 20 in the different orientations. The frame locator 32 provides for precise and repeatable workpiece 12 positioning relative to the shaft 20. When using the exemplary base fixture 21, the workpiece 12 is substantially horizontal when coupled with the base fixture 21.

In some embodiments, the machine tool system 10 includes additional machines beyond the machine 14. For example, the machine tool system 10 may include the machine 14 capable of PECM and a second machine (not shown) capable of another type of machining. The PECM machine uses the substantially planar surfaces of the arms 34, 36, 38 as primary datums to help gain surface area for power transfer.

The workpiece frame 16 is repositionable on the machine 14 and relocatable to the second machine. Thus, the workpiece 12 may be transferred to the second machine without requiring removal of the workpiece 12 from the workpiece frame 16. On the second machine, the workpiece frame 16 may be placed in different positions such that the workpiece 12 is positioned in different orientations. For example, the workpiece frame 16 may be positioned such that the body 28 opens to the right and the workpiece 12 is substantially vertical. As another example, the workpiece frame 16 may be positioned such that the body 28 opens to the left and the workpiece 12 is substantially vertical.

The second machine may be used for hole drilling via laser, cutting via laser, milling of surfaces, and/or cutting via electrical discharge machining (EDM). The second machine may also be used for inspection of the workpiece 12, for example, via non-contact three-dimensional scanning via blue light. The shaft of the second machine may move, similar to the shaft 20, or may remain stationary. The second machine may be a single axis machine or a multi axis machine.

The machine tool system 10 may include any combination of machines. For example, the machine tool system 10 may include the machine 14, the second machine capable of hole drilling via laser, a third machine capable of milling, a fourth machine capable of inspection, etc.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system comprising:
a three-dimensional workpiece,
a machine configured to modify the three-dimensional workpiece, the machine including a tool configured to support the three-dimensional workpiece and a shaft spaced apart from the tool along a first axis and configured to move along the first axis relative to the tool to modify the three-dimensional workpiece, and
a workpiece frame that is repositionable and relocatable on the tool in at least two different orientations to support the three-dimensional workpiece in the at least two different orientations relative to the first axis during modification of the three-dimensional workpiece so that different sides of the three-dimensional workpiece are modified without requiring removal of the three-dimensional workpiece from the workpiece frame, the workpiece frame including a body defining a workpiece-receiving space therein and a frame locator arranged outside of the workpiece-receiving space and extending away from the body into contact with the tool to position the workpiece frame relative to the tool so that the three-dimensional workpiece is properly aligned with the shaft in the at least two different orientations,
wherein the tool includes a base fixture configured to be coupled with the body of the workpiece frame to locate the three-dimensional workpiece relative to the shaft and an accessory fixture removably coupled with the body of the workpiece frame to locate the workpiece frame between the base fixture and the accessory fixture, the workpiece frame being repositionable and relocatable on the base fixture in the at least two different orientations,
wherein the frame locator includes a body-locating assembly and a pin, the body-locating assembly extending through the body of the workpiece frame and into the accessory fixture and the base fixture in a first direction, and the pin extending into the base fixture and into the body-locating assembly in a second direction perpendicular to the first direction to fix the body-locating assembly in position relative to the base fixture.

2. The machine tool system of claim 1, wherein the body of the workpiece frame is formed to include a through hole extending therethrough in the first direction and sized to receive the body-locating assembly therein.

3. The machine tool system of claim 2, wherein body-locating assembly includes a plug located in the through hole of the body and a sleeve extending into the plug and into the base fixture to interconnect the workpiece frame and the base fixture.

4. The machine tool system of claim 3, wherein the sleeve is formed to include a sleeve hole extending therethrough in the first direction and a groove extending into the sleeve toward the sleeve hole in the second direction, the groove sized to receive a portion of the pin therein to fix the body-locating assembly in position relative to the base fixture.

5. The machine tool system of claim 1, wherein the frame locator further includes a fastener that extends through the accessory fixture and into the body-locating assembly in the first direction to fix the accessory fixture in position relative to the workpiece frame.

6. The machine tool system of claim 1, wherein the body of the workpiece frame is formed to define a through hole extending therethrough in the first direction, the base fixture is formed to define a first hole extending into the base fixture in the first direction, and the accessory fixture is formed to define a hole extending therethrough in the first direction, the through hole of the body, the first hole of the base fixture, and the hole of the accessory fixture being aligned with one another to receive the body-locating assembly therein.

7. The machine tool system of claim 6, wherein the body-locating assembly includes a sleeve located in and extending between the through hole of the body and the first hole of the base fixture and a screw located in and extending between the hole of the accessory fixture, the through hole of the body, and the first hole of the base fixture.

8. The machine tool system of claim 7, wherein the base fixture is further formed to define a second hole extending into the base fixture in the second direction, the second hole opening into the first hole of the base fixture.

9. The machine tool system of claim 8, wherein the sleeve is formed to include a sleeve hole extending therethrough in the first direction and a groove extending into the sleeve toward the sleeve hole in the second direction, and wherein the screw is received in the sleeve hole of the sleeve and the pin extends into the second hole of the base fixture and through the groove of the sleeve.

10. A machine tool system comprising:
a workpiece,
a machine configured to modify the workpiece, the machine including a tool configured to support the workpiece and a shaft spaced apart from the tool along a first axis and configured to move along the first axis relative to the tool to modify the workpiece, and
a workpiece frame that is repositionable and relocatable on the tool in at least two different orientations to support the workpiece in the at least two different orientations relative to the first axis during modification of the workpiece so that different sides of the workpiece are modified without requiring removal of the workpiece from the workpiece frame, the workpiece frame including a body configured to be coupled to the tool and defining a workpiece-receiving space therein and a frame locator arranged outside of the workpiece-receiving space and extending away from the body into contact with the tool to position the workpiece frame relative to the tool so that the workpiece is properly aligned with the shaft in the at least two different orientations,
wherein the frame locator includes a body-locating assembly and a pin, the body-locating assembly extending through the body of the workpiece frame and into the tool in a first direction, and the pin extending into the tool and into the body-locating assembly in a second direction perpendicular to the first direction to fix the body-locating assembly in position relative to the tool thereby blocking rotating of the body-locating assembly and the workpiece frame relative to the tool.

11. The machine tool system of claim 10, wherein the body of the workpiece frame is formed to include a through hole extending therethrough in the first direction and sized to receive the body-locating assembly therein.

12. The machine tool system of claim 11, wherein the body-locating assembly includes a plug located in the through hole of the body and a sleeve extending into the plug and into the tool to interconnect the workpiece frame and the tool.

13. The machine tool system of claim 12, wherein the sleeve is formed to include a sleeve hole extending therethrough in the first direction and a groove extending into the sleeve toward the sleeve hole in the second direction, the groove sized to receive a portion of the pin therein to fix the body-locating assembly in position relative to the tool.

14. The machine tool system of claim 10, wherein the tool includes a base fixture coupled with a frame of the machine to locate the workpiece relative to the shaft and an accessory fixture removably coupled with the workpiece frame to locate the workpiece frame between the base fixture and the accessory fixture, the workpiece frame being repositionable and relocatable on the base fixture in the at least two different orientations.

15. The machine tool system of claim 14, wherein the body-locating assembly extends through the body of the workpiece frame and into both of the base fixture and the accessory fixture, and wherein the pin extends into the base fixture and the body-locating assembly to fix the body-locating assembly in position relative to the base fixture.

16. The machine tool system of claim 15, wherein the frame locator further includes a fastener that extends through the accessory fixture and into the body-locating assembly in the first direction to fix the accessory fixture in position relative to the workpiece frame.

17. The machine tool system of claim 16, wherein the body of the workpiece frame is formed to define a through hole extending therethrough in the first direction, the base fixture is formed to define a first hole extending into the base fixture in the first direction, and the accessory fixture is formed to define a hole extending therethrough in the first direction, the through hole of the body, the first hole of the base fixture, and the hole of the accessory fixture being aligned with one another to receive the body-locating assembly therein.

18. The machine tool system of claim 17, wherein the body-locating assembly includes a sleeve located in and extending between the through hole of the body and the first hole of the base fixture and a screw located in and extending between the hole of the accessory fixture, the through hole of the body, and the first hole of the base fixture.

19. The machine tool system of claim 18, wherein the base fixture is further formed to define a second hole extending into the base fixture in the second direction, the second hole opening into the first hole of the base fixture.

20. The machine tool system of claim 19, wherein the sleeve is formed to include a sleeve hole extending therethrough in the first direction and a groove extending into the sleeve toward the sleeve hole in the second direction, and wherein the screw is received in the sleeve hole of the sleeve and the pin extends into the second hole of the base fixture and through the groove of the sleeve.
